(19) United States
(12) Patent Application Publication
(10) Pub. No.: US 2007/0014580 A1
(43) Pub. Date: Jan. 18, 2007

(54) Image forming apparatus and paper error indicating method for the same

(75) Inventor: Ji-hoon Woo, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/435,871

(22) Filed: May 18, 2006

(30) Foreign Application Priority Data
Jul. 18, 2005 (KR) 2005-64780

(51) Int. Cl. G03G 15/00

(52) U.S. Cl. 399/21

(57) ABSTRACT

An image forming apparatus includes an illuminant which is disposed in a cover or a paper feed cassette to be opened in order to remove a paper error when a paper error occurs. The image forming apparatus includes a body; a jam sensing unit for detecting whether a printing medium is jammed in the body; a plurality of covers which are disposed at an external side of the body and which are opened and closed in order to remove the jammed printing medium in the body; a plurality of illuminants which are disposed at the plurality of covers, respectively; and a control unit for switching on the illuminant which is disposed in at least one of the plurality of covers as being opened in order to remove the jammed printing medium if the jam sensing unit detects that the printing medium is jammed.

### CROSS-REFERENCE TO RELATED APPLICATIONS

This application claims the benefit of Korean Patent Application No. 2005-64780, filed Jul. 18, 2005, in the Korean Intellectual Property Office, the disclosure of which is incorporated herein by reference.

### BACKGROUND OF THE INVENTION

1. Field of the Invention

Aspects of the present invention relate to an image forming apparatus, and more particularly, to an image forming apparatus having a paper error indicating function and a paper error indicating method for the image forming apparatus.

2. Description of the Related Art

In general, an image forming apparatus in which a predetermined image is formed on a printing medium may be a printer, a copier, a facsimile machine, a composite apparatus of these, etc. In a typical image forming apparatus, during the process of forming a predetermined image on the printing medium, the printing medium travels along a paper transferring section of the image forming apparatus. A plurality of sensors for sensing whether the transferred printing medium is jammed are disposed in the paper transferring section. If the printing medium is jammed during the transfer, a paper error alarm is generated, and the position where the printing medium is jammed is indicated in a liquid crystal display (LCD) portion at an operation panel of the image forming apparatus.

In a typical image forming apparatus wherein the printing medium is supplied by a paper feed cassette, a paper supply sensor senses whether the printing medium is loaded in the paper feed cassette. If no printing medium is loaded in the paper feed cassette, a paper error alarm is generated, and the LCD portion of the operation panel indicates that no printing medium is present in the paper feed cassette.

When the printing medium becomes jammed, the conventional image forming apparatus as described above indicates the position of the jammed printing medium on the operation panel. However, from the indication on the operation panel, it is difficult for a user who does not understand the structure of the image forming apparatus well to find the position of the jammed printing medium. Thus, it is common that many users open not only the covers that need to be opened to remove the jammed printing medium but also covers that do not need to be opened. As a result, the user requires a lot of time and effort to correct the paper error and to normally operate the image forming apparatus.

Moreover, when a paper cassette becomes empty in a conventional image forming apparatus that has a number of paper feed cassettes, if a lack of paper is indicated only on the operation panel, the user is frequently confused as to exactly which paper feed cassette is empty. Consequently, the user may open several or all of the paper feed cassettes to look for the empty paper feed cassette. In such a case, a lot of time and effort are required for finding which paper feed cassette is empty and then supplying the empty paper feed cassette with the printing medium.

Specifically, the aforementioned problems become serious in complex image forming apparatuses, such as composite apparatuses, in which the printing medium transferring path is complicated and in which a number of paper feed cassettes are used.

### SUMMARY OF THE INVENTION

Accordingly, it is an aspect of the present invention to provide an image forming apparatus and a paper error indicating method, which make it possible for a user to easily and instantly perceive which cover or paper feed cassette is to be opened to remove a jam or to supply a printing medium when a paper error, e.g., a printing medium jam or a lack of printing medium, occurs.

Additional aspects and/or advantages of the invention will be set forth in part in the description which follows and, in part, will be obvious from the description, or may be learned by practice of the invention.

The above and/or other aspects of the present invention are substantially realized by providing an image forming apparatus which comprises a body; a jam sensing unit that detects whether a printing medium is jammed in the body; a plurality of covers which are disposed at an external side of the body and which provide access to remove a jammed printing medium in the body; a plurality of illuminants which are disposed at the plurality of covers, respectively; and a control unit that switches on the illuminant which is disposed in at least one of the plurality of covers if the jam sensing unit detects that the printing medium is jammed, wherein the illuminant indicates that the cover in which it is disposed is to be opened in order to remove the jammed printing medium.

The image forming apparatus further comprises at least one paper feed cassette which is loaded with the printing medium and supplies the printing medium; a paper supply sensor that detects whether the printing medium to be supplied is in the paper feed cassette; and an illuminant which is disposed at the exterior of the paper feed cassette, wherein the control unit switches on the illuminant of the paper feed cassette if the paper supply sensor detects that no printing medium is in the paper feed cassette,.

If the printing medium is jammed in the body or if no printing medium is in the paper feed cassette, the control unit may cause the illuminant disposed in a corresponding cover or paper feed cassette to blink on and off.

Further, if several covers among the plurality of covers are to be sequentially opened to remove the jammed printing medium in the body, the control unit causes the illuminant disposed in the cover to be opened first to blink on and off and switches on the illuminants disposed in the remaining covers to be opened next.

In accordance with another aspect of the present invention, there is provided a paper error indicating method for an image forming apparatus, which comprises determining whether a printing medium is in a paper feed cassette; and switching on an illuminant which is disposed at the exterior of the paper feed cassette when no printing medium is in the paper feed cassette. If no printing medium is in a paper feed cassette, it may be possible to cause the illuminant disposed at the exterior of the paper feed cassette to blink on and off.

The paper error indicating method for the image forming apparatus further comprises transferring the printing medium if the printing medium is in the paper feed cassette; determining whether a jam occurs during the transfer of the printing medium; and, if it is determined that a jam occurs during the transfer of the printing medium, then switching on the illuminant disposed in the cover that provides access to remove the jammed printing medium. The illuminant that was switched on may then be switched off when the jammed printing medium has been removed.

Herein, if the jam is such that it requires that more than one cover be opened in sequence, the paper error indicating method for the image forming apparatus may comprise causing the illuminant disposed in a cover to be opened first to blink on and off, and switching on the illuminants disposed in the remaining covers that are required to be opened; switching on the illuminant of the cover to be first opened, and causing the illuminants of the next covers to blink on and off when the jammed printing medium is removed from the internal side of the cover that is opened first; repeating the preceding steps until the printing medium that was jammed at the internal side of the number of covers is completely removed; and switching off all the illuminants of the number of covers that were switched on when the jammed printing medium is completely removed.

In accordance with the image forming apparatus and the paper error indicating method for the image forming apparatus of the present invention as described above, when a printing medium that is being transferred is jammed in the body, a user can easily and immediately perceive which cover is to be opened since the illuminant of the cover to be opened in order to remove the jam is switched on or is caused to blink on and off.

Furthermore, when no printing medium is present in the paper feed cassette, the user can easily and instantly perceive which paper feed cassette is to be loaded with the printing medium since the illuminant disposed at the front side of the paper feed cassette to be supplied with the printing medium is switched on or is caused to blink on and off.

Consequently, in accordance with the image forming apparatus and the paper error indicating method for the image forming apparatus according to aspects of the present invention, it is possible to save the time and effort required for correcting paper errors since the user can easily understand which cover or which paper feed cassette needs to be opened to solve the paper error.

According to another aspect of the present invention, an image forming apparatus comprises a body having a printing medium transfer path that transfers a printing medium through the body; a plurality of jam sensing sensors disposed at particular locations along the printing medium transfer path, each of which detects whether a printing medium is jammed at the respective particular location along the printing medium transfer path; a plurality of covers that are disposed at an external side of the body, each of which provides access to a particular location of the internal path sensed by a respective jam sensing sensor; a plurality of illuminants that are disposed at the plurality of covers, respectively; and a control unit that switches on an illuminant that is disposed in a particular one of the plurality of covers if a respective jam sensing sensor detects that the printing medium is jammed at the location to which the cover provides access.

According to another aspect of the present invention, a method is provided to indicate a printing medium error in an image forming apparatus comprising a plurality of printing medium feed cassettes, the method comprising: determining when a particular one of the plurality of printing medium feed cassettes has been selected to supply a printing medium; determining whether a printing medium is present in the selected printing medium feed cassette; and switching on an illuminant which is disposed at an external side of the selected printing medium feed cassette, or causing the illuminant to blink on and off, when no printing medium is present in the printing medium feed cassette. The method may further comprise transferring the printing medium along a printing medium transfer path through the image forming apparatus if the printing medium is in the selected printing medium feed cassette; determining whether a jam of the printing medium occurs during the transfer of the printing medium; and, if determined that a jam has occurred during the transfer of the printing medium, then locating the jam along the printing medium transfer path and switching on an illuminant disposed in a cover that provides access to remove the jammed printing medium.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a front view of an image forming apparatus according to one embodiment of the present invention;

FIG. 2 is a cross-sectional view schematically showing the image forming apparatus of FIG. 1;

FIG. 3 is a block diagram showing an operation of a paper error indicating method for the image forming apparatus of FIG. 1; and

FIG. 4 is a flow chart of the paper error indicating method for the image forming apparatus shown in FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. Where the function and structure are well-known in the relevant arts, further discussion will not be presented in the detailed description or illustration of the present invention in order not to unnecessarily make the gist of the present invention unclear. Below, a composite apparatus in which a printing medium transferring path is complicated and a number of paper feed cassettes are disposed will be described as an example.

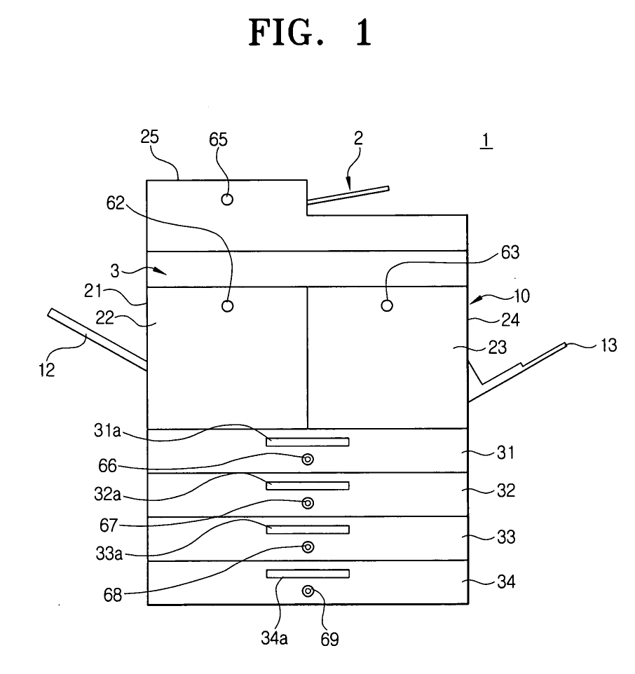

With reference to FIGS. 1 to 3, an image forming apparatus 1 according to one embodiment of the present invention comprises a body 10, a plurality of covers 21, 22, 23 and 24, a plurality of paper feed cassettes 31, 32, 33 and 34, a jam sensing unit 41, 42, 43, 44 and 45, a plurality of illuminants 61, 62, 63, 64, 65, 66, 67, 68 and 69, and a control unit 70.

An original document feed unit 2 is disposed at the upper side of the body 10. The original document feed unit 2 supplies sheets of an original document, one by one, to a scan unit 3 for copying or scanning.

The scan unit 3, an image forming unit 5, the plurality of paper feed cassettes 31, 32, 33 and 34 are disposed in turn, from the upper part toward the lower part, at the internal side of the body 10. A paper transfer unit 4 is provided at one side of the plurality of paper feed cassettes 31, 32, 33 and 34 and at one side of the image forming unit 5, to transfer a printing medium as loaded in the plurality of paper feed cassettes 31, 32, 33 and 34 to the image forming unit 5. A multi-purpose paper feed tray 12 is disposed at one side of the paper transfer unit 4, to supply printing media of various kinds. Typically, the printing medium is paper, particularly sheets of paper. However, it is to be understood other printing media can be used. In particular, any other printing medium, such as, for example, plastic or textile, that is in a form that can be transferred by a transfer unit and that can be fixed with a printed image can be used according to an aspect of the present invention. While the present embodiment is described with terms such as “paper feed cassette”, “paper transfer unit”, “paper supply sensor”, “paper eject roller” and “paper eject tray” that relate to the image forming apparatus when it is using paper as the printing medium, it is to be understood that an image forming apparatus when it is using other printing media may have these structures, which can be described more generally as a printing medium feed cassette, printing medium transfer unit, printing medium supply sensor, printing medium eject roller and printing medium eject tray, respectively. An operation panel (not shown) may be disposed at one side of the scan unit 3, to operate the image forming apparatus 1 and may include a liquid crystal display (LCD) unit 14 to indicate the state of the image forming apparatus 1.

The image forming unit 5 comprises a photosensitive medium 6, an image transfer roller 7, and a fixing unit 8. The photosensitive medium 6 forms a predetermined image corresponding to printing data, and the image transfer roller 7 transfers the image as formed in the photosensitive medium 6 onto the printing medium as supplied by the paper transfer unit 4. The fixing unit 8 comprises a pressure roller and a heating roller, to fix the transferred image on the printing medium at a high temperature and high pressure. The paper eject roller 9 ejects the printing medium having the fixed image to a paper eject tray 13.

The plurality of paper feed cassettes 31, 32, 33 and 34 are loaded with a predetermined printing medium, respectively, and pickup rollers 35, 36, 37 and 38 are disposed at the front ends of the paper feed cassettes 31, 32, 33 and 34, respectively, to pick up a sheet of the printing medium as loaded and to supply it to the paper transfer unit. Paper supply sensors 51, 52, 53 and 54 are disposed in the paper feed cassettes 31, 32, 33 and 34, respectively, to sense whether a printing medium is present. In this embodiment, four paper feed cassettes, i.e., first, second, third and fourth paper feed cassettes 31, 32, 33 and 34, are provided. First, second, third and fourth pickup rollers 35, 36, 37, 38 and first, second, third and fourth paper supply sensors 51, 52, 53 and 54 are disposed in the paper feed cassettes 31, 32, 33 and 34, respectively.

The paper transfer unit 4 comprises a number of transfer rollers 16 and 17 for transferring the printing medium, which is picked up from one of the plurality of paper feed cassettes 31, 32, 33 and 34, to the image forming unit 5.

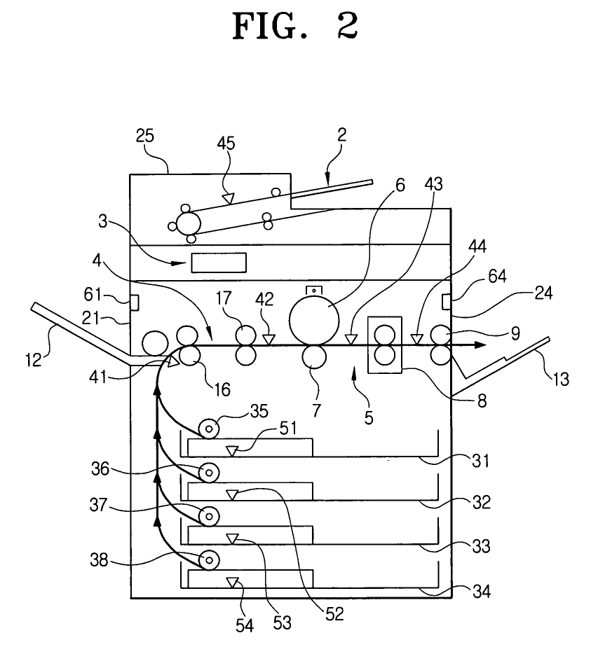

The plurality of covers 21, 22, 23 and 24 are disposed at the external side of the body so that they can be opened and closed. The plurality of covers 21, 22, 23 and 24 can vary in shape and quantity according to the structure of the image forming apparatus 1. In the image forming apparatus 1 according to the embodiment of the present invention illustrated in FIGS. 1 and 2, four covers 21, 22, 23 and 24 are disposed at the front side and both sides of the body 10 so as to be opened and closed in order to provide access to remove a printing medium that becomes jammed in the paper transfer unit 4 and the image forming unit 5. Each cover 21, 22, 23 and 24 may provide access to a particular section or portion of a traveling path of a printing medium through the image forming apparatus 1. For example, in the image forming apparatus 1 according to the present embodiment, a first cover 21 is disposed at the left side of the body 10 in order to remove a printing medium that becomes jammed when the printing medium is being transferred from the plurality of paper feed cassettes 31, 32, 33 and 34, a second cover 22 is disposed at the front side of the body 10 to remove a printing medium that becomes jammed between the second transfer roller 17 and the photosensitive medium 6, a third cover 23 is disposed at one side of the second cover 22 in the front side of the body 10 to remove printing medium that becomes jammed between the photosensitive medium 6 and the fixing unit 8, and a fourth cover 24 is disposed at the right side of the body 10 to remove a printing medium that becomes jammed in the paper eject roller 9. In addition, a fifth cover 25 is disposed at the upper side of the original document feed unit 2 to remove an original document if it becomes jammed in the original document feed unit 2.

The jam sensing unit is disposed internally in the body 10, to detect when the printing medium becomes jammed during its transfer from one of the plurality of paper feed cassettes 31, 32, 33 and 34 through the body 10 to the paper eject tray 13. The jam sensing unit comprises a plurality of jam sensing sensors 41, 42, 43, 44 and 45 which are disposed between the constituents of the paper transfer unit 4 and the image forming unit 5 and at the original document feed unit 2. In the image forming apparatus 1, the jam sensing unit comprises five jam sensing sensors 41, 42, 43, 44 and 45. That is, the jam sensing unit comprises a first jam sensing sensor 41 which is disposed in front of the first transfer roller 16, a second jam sensing sensor 42 disposed between the second transfer roller 17 and the photosensitive medium 6, a third sensing sensor 43 disposed between the photosensitive medium 6 and the fixing unit 8, a fourth sensing sensor 44 disposed between the fixing unit 8 and the paper eject roller 9, and a fifth sensing sensor 45 disposed in the original document feed unit 2. Other locations for jam sensing sensors are possible.

A plurality of illuminants 61, 62, 63, 64, 65, 66, 67, 68 and 69 are disposed in the plurality of covers 21, 22, 23, 24 and 25 and the plurality of paper feed cassettes 31, 32, 33 and 34, respectively. The plurality of illuminants 61, 62, 63, 64, 65, 66, 67, 68 and 69 should be disposed such that when they are switched on, a user can easily perceive the lighting of the illuminants and can easily determine which cover or paper feed cassette a particular illuminant is disposed in. For this purpose, for example, a transparent window (not shown) may be provided in a part of each of the plurality of covers 21, 22, 23 and 24, and the illuminant may be positioned behind the transparent window. Then, when the illuminant is switched on, it can be perceived outside through the transparent window. In each of the plurality of paper feed cassettes 31, 32, 33 and 34, the transparent window may be formed on the side where each of handles 31a, 32a, 33a and 34a is positioned to put each of the paper feed cassettes 31, 32, 33 and 34 in or to take it out the body 10 (hereinafter, the side is referred to as the front side of the paper feed cassette), and the illuminant may be disposed behind the transparent window. Then, when the illuminant is switched on, the user can perceive the lighting of the illuminant outside through the transparent window. Of course, it can be also expected that the illuminants 61, 62, 63, 64, 65, 66, 67, 68 and 69 can be disposed in the plurality of covers 21, 22, 23, 24 and 25 and the plurality of paper feed cassettes 31, 32, 33 and 34, respectively, in other ways. For example, an illuminant of a paper feed cassette or of a cover can be disposed anywhere on an exterior of the paper feed cassette or the cover, respectively, that can be perceived by a user.

Herein, any illuminating device that can be selectively switched on or off by the control unit 70 can be used as the illuminants 61, 62, 63, 64, 65, 66, 67, 68 and 69. For example, a light emitting diode (LED) or miniature bulb may be used for this purpose. Herein, the light-emitting color of the illuminants 61, 62, 63, 64 and 65 disposed in the plurality of covers 21, 22, 23, 24 and 25, respectively, may be different from the color of the illuminants 66, 67, 68 and 69 disposed in the plurality of paper feed cassettes 31, 32, 33 and 34, respectively. For example, green color illuminants may be disposed in the covers 21, 22, 23, 24 and 25, respectively, and red color illuminants may be disposed in the paper feed cassettes 31, 32, 33 and 34, respectively. Then, by perceiving the color of the illuminants 61, 62, 63, 64, 65, 66, 67, 68 and 69 only, the user can easily perceive whether the printing medium is jammed or whether one of the paper feed cassettes 31, 32, 33 and 34 is empty, and thus, can take proper measures.

The control unit 70 switches the illuminants 61, 62, 63, 64, 65, 66, 67, 68 and 69 on or off according to signals from the plurality of jam sensing sensors 41, 42, 43, 44 and 45 and the plurality of paper supply sensors 51, 52, 53 and 54. Each of the plurality of jam sensing sensors 41, 42, 43, 44 and 45 respectively corresponds to one of the plurality of illuminants 61, 62, 63, 64 and 65 which are disposed in the plurality of covers 21, 22, 23, 24 and 25, respectively. The control unit 70 remembers the corresponding relations between the plurality of jam sensing sensors 41, 42, 43, 44 and 45 and the plurality of illuminants 61, 62, 63, 64 and 65 which are disposed in the plurality of covers 21, 22, 23, 24 and 25, respectively. Further, each of the plurality of paper supply sensors 51, 52, 53 and 54 respectively corresponds to one of the illuminants 66, 67, 68 and 69 which are disposed in the plurality of paper feed cassettes 31, 32, 33 and 34, respectively. The control unit 70 remembers the corresponding relations between the plurality of paper supply sensors 51, 52, 53 and 54 and the illuminants 66, 67, 68 and 69 which are disposed in the plurality of paper feed cassettes 31, 32, 33 and 34, respectively. Thus, when a printing medium being transferred in the body 10 becomes jammed, the control unit 70 perceives the position of the jammed printing medium according to the signals of the jam sensing sensors 41, 42, 43, 44 and 45 in operation and switches on one or more of the illuminants 61, 62, 63, 64 and 65 which are disposed in the covers 21, 22, 23, 24 and 25, respectively, to indicate which cover needs to be opened in order to remove the jammed printing medium at that position. Further, when one of the plurality of paper feed cassettes runs out of paper, the control unit 70 perceives the out-of-paper condition according to a signal received from the corresponding one of the paper supply sensors 51, 52, 53 and 54 and switches on the corresponding one of the illuminants 66, 67, 68 and 69 which are disposed in corresponding paper feed cassettes 31, 32, 33 and 34, respectively to indicate which one of the paper feed cassettes 31, 32, 33 and 34 is out of paper.

If a number of covers 21, 22, 23 and 24 need to be opened to remove a printing medium that is jammed in the body, the control portion 70 switches on all of the particular illuminants 61, 62, 63 and 64 disposed in the particular covers 21, 22, 23 and 24 that need to be opened. Herein, if a number of covers 21, 22, 23 and 24 need be sequentially opened to remove the jammed printing medium, the control unit 70 may switch the illuminants 61, 62, 63 and 64 on and off in the required order. For example, when a number of covers 21, 22, 23 and 24 need be sequentially opened, the control unit 70 causes the illuminant which is disposed in the cover to be opened first to blink on and off and switches on remaining illuminants on the covers that need to be opened. When the user opens the cover to be opened first and removes the jammed printing medium, the control unit 70 switches on the illuminant of that cover (for example, causes that illuminant to be steadily lit) and causes the illuminant of the cover to be opened next to blink on and off. When the user opens the cover to be opened next and removes the jammed printing medium, the control unit 70 switches on the illuminant of that cover and causes the illuminant of the cover to be opened next after that to blink on and off. When the jammed printing medium is completely removed by repeatedly performing the aforementioned processes, the control unit 70 switches off all of the illuminants 61, 62, 63 and 64 that had been switched on. If a number of covers 21, 22, 23 and 24 need be sequentially opened to remove the jammed printing medium, the control unit 70 is not limited to a control unit that carries out the functions as specifically described herein, but may be any control unit that communicates through the illuminants to notify a user of the order in which the covers 21, 22, 23, and 24 need to be opened. For example, the control unit 70 may switch the illuminants on and off by any combination or sequence of steady illumination or rapid or slow blinking.

Further, when the printing medium is jammed in the body 10, the control unit 70 may indicate the position of the jammed printing medium through the liquid crystal display (LCD) unit 14 and may generate a beeping sound through a speaker to provide an alarm.

Since the operations of scanning and copying an original document and printing by the image forming apparatus 1, and the control of these functions by the control unit 70, are the same as those of a conventional image forming apparatus, a detailed description thereof will not be presented.

Below, the operations of the image forming apparatus 1 according to aspects of the present invention in the above-described structure will be described in detail in reference to FIGS. 1 and 2.

For printing, the control unit 70 sets the image forming apparatus to be in a print mode and sets the paper feed cassettes 31, 32, 33 and 34 to feed the printing medium. The control unit 70 detects whether the printing medium to be fed is present in the paper feed cassettes 31, 32, 33 and 34, based on signals received from the paper supply sensors 51, 52, 53 and 54 disposed in the paper feed cassettes 31, 32, 33 and 34. The control unit may determine that a particular printing medium feed cassette has been selected to supply a printing medium and may detect whether a printing medium is present in the selected printing medium feed cassette. For example, when printing is to be done using printing medium loaded from the first paper feed cassette 31, the control unit 70 detects whether the printing medium is present in the first paper feed cassette 31, based on a signal received from the first paper supply sensor 51. If no printing medium is present in the first paper feed cassette 31, the control unit 70 switches on the illuminant 66 that is disposed at the front side of the first feed cassette 31. Simultaneously, the control unit 70 indicates which paper feed cassette has run out of the printing medium by sending an error message to the LCD unit 14 and generates a beeping sound to warn the user. Then, by perceiving that illuminant 66 is switched on, the user can easily perceive that the paper feed cassette to be supplied with the printing medium is the first paper feed cassette 31. When the user opens the first paper feed cassette 31 and loads it with the printing medium, the control unit 70 switches off the illuminant 66.

If the printing medium is present in the paper feed cassettes 31, 32, 33 and 34, the control unit 70 picks up sheets of the printing medium one by one with the pickup rollers 35, 36, 37 and 38, and supplies the printing medium to the paper transfer unit 4. Then, the control unit 70 transfers the printing medium to the image forming unit 5 through the paper transfer unit 4 and forms the image on the printing medium. During this process, the control portion 70 detects whether a jam of the printing medium occurs during the transfer of the printing medium, by way of the plurality of jam sensing sensors 41, 42, 43 and 44 that are positioned at various sections along the printing medium transfer path.

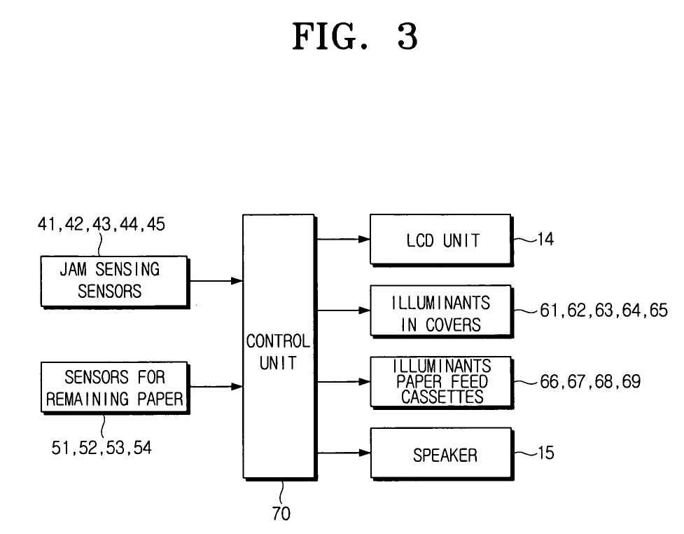

If a jam of the printing medium occurs, the control unit 70 determines which of the plurality of jam sensing sensors 41, 42, 43, 44 and 45 has detected the jam, and it switches on the illuminant of the cover which corresponds to the jam sensing sensor that has detected the jam. In particular, the control unit 70 switches on the illuminant of the cover that needs to be opened to provide access to the jam detected by the jam sensing sensor. For example, if the second jam sensing sensor 42 as shown in FIG. 2 has detected a jam, the control unit 70 switches on the illuminant 62 of the second cover 22 (in reference to FIG. 1), which is the cover that needs to be opened to remove a jam from a location detected by the jam sensing sensor 42. Simultaneously, the control unit 70 activates an error message on the LCD unit 14 (in reference to FIG. 3) that indicates the position where the printing medium is jammed and generates a beeping sound to warn the user of the paper error. When the user opens the second cover 22 and removes the jammed printing medium, the control unit 70 switches off the illuminant 62 of the second cover 22.

If a number of covers need to be opened in order to remove a printing medium that has jammed in the body 10, the control unit 70 switches on and off the illuminants in the order that covers should be opened. For example, if the first and second covers 21 and 22 are to be opened to remove the jammed printing medium, the control unit 70 determines the order in which the first and second covers 21 and 22 should be opened. If the control unit 70 determines that the first cover 21 is to be opened first and the second cover 22 is to be opened next to remove the jammed printing medium, the control unit 70 causes the illuminant 61 of the first cover 21 to blink on and off and keeps the illuminant 62 of the second cover 22 steadily lit. Then, the user can know that the first and second covers 21 and 22 should be opened and specifically, that the first cover 21 should be opened first to remove the jam. When the user opens the first cover 21 and removes the jammed printing medium, the control unit 70 keeps the illuminant 61 of the first cover 21 steadily lit and causes the illuminant 62 of the second cover 22 to blink on and off. Then, after the user opens the second cover 22 and removes the jammed printing medium, the control unit 70 switches off both illuminants 61, 62.

Below, in accordance with aspects of the present invention, a paper error indicating method of an image forming apparatus will be described.

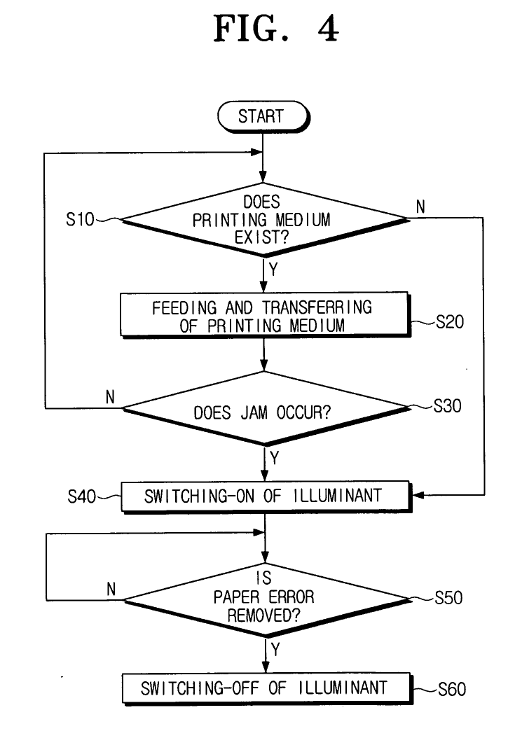

With reference to FIGS. 1 to 4, a paper error indicating method of an image forming apparatus according to an embodiment of the present invention comprises the steps of: determining whether a printing medium to be supplied is present in paper feed cassettes 31, 32, 33 and 34 (S10); picking up and transferring the printing medium from one of the paper feed cassettes 31, 32, 33 and 34 (S20); determining whether a jam of the printing medium occurs (S30); emitting light by switching on the corresponding illuminants 61, 62, 63, 64, 65, 66, 67, 68 and 69 if a jam occurs or if no printing medium is present (S40); determining whether a paper error is fixed (S50); and switching off the illuminants 61, 62, 63, 64, 65, 66, 67, 68 and 69 that were switched on when the paper error is fixed (S60).

At the determining of the presence of the printing medium (S10), the control unit 70 determines whether the printing medium to be used for printing is loaded in the paper feed cassette, for example, whether the printing medium to be supplied to the first paper feed cassette 31 is loaded, by receiving or not receiving a signal from the paper supply sensor 51, which is disposed in the first paper feed cassette 31. If no printing medium is present in the first paper feed cassette 31, the control unit 70 proceeds with the emitting of light (S40), and it switches on the illuminant 66 that is disposed at the front side of the first paper feed cassette 31. The control unit 70 may switch on and off the illuminant 66 of the first paper feed cassette 31, in which no printing paper exists. For example, the control unit 70 may cause the illuminant 66 to blink, thereby further getting the attention of a user. Subsequently, the control unit 70 determines whether the paper error is fixed (S50). When the user loads the first paper feed cassette 31 with the printing medium so that the paper error is fixed, the control unit 70 switches off the illuminant 66 of the first paper feed cassette 31 (S60).

If the printing medium is present in the first paper feed cassette 31 at the determining of the presence of the printing medium (S10), the control unit 70 proceeds with the transferring of the printing medium (S20) to the image forming unit. Simultaneously, the control unit 70 determines whether a jam occurs during the transfer of the printing medium, by way of the plurality of jam sensing sensors 41, 42, 43, 44 and 45 (S30). If the printing medium is jammed, the control unit 70 switches on the illuminants 61, 62, 63, 64 and 65 as disposed in the covers 21, 22, 23, 24 and 25, respectively, that need to be opened in order to remove the jammed printing medium (S40). For example, if the second jam sensing sensor 42 detects the jam of the printing medium, the control unit 70 switches on the illuminant 62 as disposed in the second cover 22. The control unit 70 may switch on and off the particular illuminants 61, 62, 63, 64 and 65 that are disposed in the covers 21, 22, 23, 24 and 25 that need to be opened to remove the jam. For example, the control unit 70 may cause the illuminants 61, 62, 63, 64 and 65 to blink, thereby further getting the attention of a user. Since this operation is same as that of the image forming apparatus 1 as described in detail above, further description will not be presented. When the user removes the jammed printing medium, the control unit 70 determines whether the paper error has been fixed and it switches off the illuminants 61, 62, 63, 64 and 65 that were switched on.

If a number of covers 21, 22, 23 and 24 need to be sequentially opened in order to remove the printing medium jammed in the body 10, the control unit 70 indicates the order of opening the covers according to the operations below:

To indicate the order of opening of the covers to remove the jammed printing medium, the illuminant disposed in the cover to be opened first is made to blink on and off, and the illuminants disposed in the remaining covers are switched on.

If the printing medium jammed in the internal side of the cover to be opened first is removed, the illuminant of the cover to be first opened is switched on, and the illuminant of the cover to be next opened is made to blink on and off.

The aforementioned processes are subsequently performed until the printing medium as jammed in the internal side of the number of covers is completely removed.

Then, when the jammed printing medium is completely removed, the illuminants that were switched on are all switched off.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus comprising:
a body;
a jam sensing unit that detects whether a printing medium is jammed in the body;
a plurality of covers which are disposed at an external side of the body and which are opened and closed in order to provide access to remove a printing medium if jammed in the body;
a plurality of illuminants which are disposed at the plurality of covers, respectively; and
a control unit to switch on the illuminant which is disposed in at least one of the plurality of covers if the jam sensing unit detects that the printing medium is jammed, wherein the illuminant indicates that the cover in which the illuminant is disposed is to be opened in order to remove the jammed printing medium.

2. The apparatus as claimed in claim 1, further comprising:
at least one printing medium feed cassette which is loaded with the printing medium and supplies the printing medium;
a printing medium supply sensor that detects whether the printing medium to be supplied is in the paper feed cassette; and
an illuminant which is disposed at an external side of each printing medium feed cassette,
wherein the control unit switches on the illuminant of the printing medium feed cassette when the printing medium supply sensor detects that no printing medium is in the printing medium feed cassette.

3. The apparatus as claimed in claim 2, wherein if the printing medium is jammed in the body or if no printing medium is in the printing medium feed cassette, the control unit causes the illuminant disposed in a corresponding cover or printing medium feed cassette to blink on and off.

4. The apparatus as claimed in claim 1, wherein if several covers among the plurality of covers are to be sequentially opened to remove the jammed printing medium in the body, the control unit causes the illuminant disposed in the cover to be opened to blink on and off and switches on the illuminants disposed in the remaining covers to be opened next.

5. The image forming apparatus of claim 1, wherein the printing medium is paper, the printing medium feed cassette is a paper feed cassette and the printing medium supply sensor is a paper supply sensor.

6. The image forming apparatus of claim 2, wherein the plurality of illuminants which are disposed at the plurality of covers and the illuminant disposed in each printing medium feed cassette are light emitting diodes or miniature bulbs.

7. The image forming apparatus of claim 2, wherein the plurality of illuminants which are disposed at the plurality of covers have a different light-emitting color from that of the illuminant disposed in each printing medium feed cassette

8. A printing medium error indicating method for an image forming apparatus, comprising:
determining whether a printing medium is in a printing medium feed cassette; and
switching on an illuminant which is disposed at an external side of the printing medium feed cassette when no printing medium is in the printing medium feed cassette.

9. The method as claimed in claim 8, wherein if no printing medium is in the printing medium feed cassette, the illuminant disposed at an external side of the printing medium feed cassette is switched on and off.

10. The method as claimed in claim 8, further comprising the steps of:
transferring the printing medium if the printing medium is in the printing medium feed cassette;
determining whether a jam of the printing medium occurs during the transfer of the printing medium; and, if determined that a jam has occurred during the transfer of the printing medium, then
switching on an illuminant disposed in a cover that provides access to remove the jammed printing medium.

11. The method as claimed in claim 10, further comprising the step of switching off the illuminant which is switched on after the jammed printing medium has been removed.

12. The method as claimed in claim 10, wherein if the printing medium is jammed, the illuminant disposed in the cover that provides access to remove the jammed printing medium is switched on and off.

13. The method as claimed in claim 10, further comprising:
determining if removal of the jam requires that more than one cover be opened in sequence and causing the illuminant disposed in a cover to be opened first to blink on and off, and switching on the illuminants disposed in the remaining covers of the covers that are required to be opened;
determining if a jammed printing medium has been removed by access provided by the cover that is opened first and switching on the illuminant of the cover that is opened first, and causing the illuminants of the next cover to be opened to blink on and off;
repeating the preceding steps until the printing medium that was jammed at the internal side of the number of covers is completely removed; and
switching off all the illuminants of the number of covers that have been switched on when the jammed printing medium has been completely removed.

14. An image forming apparatus comprising:
a body having a printing medium transfer path that transfers a printing medium through the body;
a plurality of jam sensing sensors disposed at particular locations along the printing medium transfer path, each of which detects whether a printing medium is jammed at the respective particular location along the printing medium transfer path;
a plurality of covers that are disposed at an external side of the body, each of which provides access to a particular location of the internal path sensed by a respective jam sensing sensor;
a plurality of illuminants that are disposed at the plurality of covers, respectively; and
a control unit that switches on an illuminant that is disposed in a particular one of the plurality of covers if a respective jam sensing sensor detects that the printing medium is jammed at the location to which the cover provides access.

15. The image forming apparatus of claim 14, wherein if one or more jam sensing sensors detects that the printing medium is jammed at a location that requires more than one of the plurality of covers to be opened in a specific sequence in order for the jammed printing medium to be removed, the control unit switches on the illuminants disposed in the more than one of the plurality of covers or causes the illuminants to blink in indicate a sequence in which the more than one of the plurality of covers is to be opened.

16. The image forming apparatus of claim 14, further comprising:
at least one printing medium feed cassette which is loaded with the printing medium and supplies the printing medium;
a printing medium supply sensor that detects whether the printing medium to be supplied is in the paper feed cassette; and
an illuminant which is disposed at an external side of each printing medium feed cassette,
wherein the control unit switches on the illuminant of the printing medium feed cassette when the printing medium supply sensor detects that no printing medium is in the printing medium feed cassette.

17. The apparatus of claim 15, wherein the image forming apparatus comprises a plurality of printing medium feed cassettes, each printing medium feed cassette having a printing medium supply sensor and each printing medium feed cassette having an illuminant disposed at an external side of the printing medium feed cassette and wherein the control unit determines when a particular one of the plurality of printing medium feed cassettes has been selected to supply a printing medium and switches on the illuminant of the selected printing medium feed cassette when the printing medium supply sensor of the selected printing medium feed cassette detects that no printing medium is in the selected printing medium feed cassette.

18. A method to indicate a printing medium error in an image forming apparatus comprising a plurality of printing medium feed cassettes, the method comprising:
determining when a particular one of the plurality of printing medium feed cassettes has been selected to supply a printing medium;
determining whether the printing medium is present in the selected printing medium feed cassette; and
switching on an illuminant which is disposed at an external side of the selected printing medium feed cassette, or causing the illuminant to blink on and off, when no printing medium is present in the printing medium feed cassette.

19. The method of claim 18, further comprising:
transferring the printing medium along a printing medium transfer path through the image forming apparatus if the printing medium is in the selected printing medium feed cassette;
determining whether a jam of the printing medium occurs during the transfer of the printing medium; and, if determined that a jam has occurred during the transfer of the printing medium, then
locating the jam along the printing medium transfer path and
switching on an illuminant disposed in a cover that provides access to remove the jammed printing medium.

20. The method of claim 19, further comprising:
determining if removal the jam requires that a plurality of covers be opened in sequence and causing the illuminant disposed in of the plurality of covers to blink or be steadily lit to indicate the sequence in which the plurality of covers are to be opened in order to remove the jam, and
switching off all the illuminants of the number of covers that have been switched on when the jammed printing medium has been completely removed.
